(19) United States
(12) Patent Application Publication
(10) Pub. No.: US 2009/0000376 A1
(43) Pub. Date: Jan. 1, 2009

(54) LIQUID LEVEL DETECTING APPARATUS

(75) Inventors: Yasunori KAWAGUCHI, Shimada-shi (JP); Toshio OIKE, Shimada-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/139,214

(22) Filed: Jun. 13, 2008

(30) Foreign Application Priority Data
Jun. 28, 2007 (JP) 2007-170307

(51) Int. Cl. G01F 23/32

(52) U.S. Cl. 73/317

(57) ABSTRACT

A liquid level detecting apparatus includes a resistance plate which includes an insulating plate and a resistor mounted on the insulating plate, the resistor having a plurality of conductive segments, and a sliding body which has a contact for contacting on the conductive segments, and the contact sliding over the conductive segments in accordance with a change of a liquid level of a liquid. At least a surface of a constituent member of the sliding body except for the contact is comprised of a material having a corrosion resistance to the liquid.

### BACKGROUND

This invention relates to a liquid level detecting apparatus, and more particularly to a liquid level detecting apparatus capable of detecting a liquid level within a fuel tank of an automobile using as fuel an electrolyte (alcohol) (such as ethanol, methanol, etc.) itself or gasoline containing such electrolyte.

There are known conventional liquid level detecting apparatuses for detecting a liquid level of a fuel tank of an automobile, in which a contact provided at a sliding body is slid over a resistance plate by a float moving upward and downward in accordance with the liquid level, and the liquid level is converted into a potential difference, thereby detecting the liquid level (see, for example, Patent Literature 1 and Patent Literature 2). Patent Literature 1 discloses the specific structure of a liquid level sensor, and this liquid level sensor is aimed at reducing the number of component parts and also at achieving a compact design. In a sliding-type detector disclosed in Patent Literature 2, materials for electrodes and a contact are specified, and the sulfidization of the contact by impurities such as sulfide components contained in fuel of the automobile is prevented, thereby securing the electrical contact.

[Patent Literature 1] JP-B-3,898,913

[Patent Literature 2] JP-A-2002-202179

The liquid level detecting apparatus is often used in a fuel tank of an automobile for holding as fuel an electrolyte (alcohol) (such as ethanol, methanol, etc.) itself or gasoline containing such electrolyte. In the conventional liquid level detecting apparatuses, the sliding body is usually made of copper alloy such as nickel silver for a spring and phosphor bronze for a spring, and a float arm is usually formed of a galvanized steel wire. When such a liquid level detecting apparatus is immersed in an electrolyte or gasoline containing an electrolyte, there has been encountered a problem that the sliding body made of the copper alloy reacts with the electrolyte, and is corroded. Furthermore, copper dissolved into the electrolyte deposits on the galvanized float arm, and liquefies zinc lower in reactivity than copper because there is no electrical connection, and this has invited a problem that the durability is lowered.

The liquid level sensor disclosed in Patent Literature 1 is specified in its structure, and by doing so, the number of the component parts is reduced, and also the compact design is achieved. However, it is not taken into consideration to use an electrolyte, gasoline containing the electrolyte, etc., as fuel (liquid) whose level is to be detected, and there is no mention of the material of the sliding body including the contact. In the sliding-type detector disclosed in Patent Literature 2, the electrodes are made of sliver alloy containing glass, and also the contact is made of gold or gold alloy so as to prevent the sulfidization of the contact and the electrodes by sulfide components contained in the fuel. However, the deterioration of other metallic parts than the contact, as well as the fuel composed solely of an electrolyte or containing an electrolyte, is not taken into consideration.

### SUMMARY

This invention has been made in view of the above circumstances, and an object of the invention is to provide a liquid level detecting apparatus in which metallic parts are prevented from deterioration and corrosion as when these parts are immersed in an electrolyte, and a liquid level of a fuel tank of an automobile using ethanol or ethanol-mixed gasoline as fuel can be precisely detected for a long period of time.

The above object has been achieved by a liquid level detecting apparatus of the present invention having features recited in the following Paragraphs (1) to (5).

(1) A liquid level detecting apparatus comprising:

a resistance plate which includes an insulating plate and a resistor mounted on the insulating plate, the resistor having a plurality of conductive segments; and

a sliding body which has a contact for contacting on the conductive segments, and the contact sliding over the conductive segments in accordance with a change of a liquid level of a liquid,

wherein at least a surface of a constituent member of the sliding body except for the contact is comprised of a material having a corrosion resistance to the liquid.

(2) Preferably, the constituent member of the sliding body except for the contact is comprised of stainless steel.

(3) The liquid level detecting apparatus further comprises:

a float which is displaced in accordance with the change of the liquid level of the liquid; and

a float arm which interconnects the sliding body and the float, and moves the sliding body in accordance with a displacement of the float,

wherein the float arm is comprised of the stainless steel.

(4) Preferably, the constituent member of the sliding body except for the contact is comprised of copper alloy, and is plated with nickel or gold.

(5) Here, it is preferable that, the copper alloy is nickel silver for a spring or phosphor bronze for the spring. The nickel silver for the spring or the phosphor bronze for the spring is prevented from a dissolving of copper by the plated nickel or the plated gold.

In the liquid level detecting apparatus of the above Paragraph (1), at least the surface of the constituent member of the sliding body except for the contact is comprised of the material having the corrosion resistance to the liquid whose liquid level is to be detected, and therefore will not be corroded by this liquid. Therefore, the constituent member is prevented from deterioration, and an excellent durability thereof can be maintained.

In the liquid level detecting apparatus of the above Paragraph (2), the constituent member of the sliding body except for the contact is comprised of stainless steel, and therefore chromium (Cr) contained in the stainless steel reacts with oxygen (O₂), contained in an electrolyte or gasoline containing an electrolyte, to form an oxide film (passive film) of a high corrosion resistance on the surface of the constituent member. Therefore, the corrosion and deterioration of the constituent member are prevented, and the excellent durability can be maintained.

In the liquid level detecting apparatus of the above Paragraph (3), the float arm interconnecting the sliding body and the float is comprised of the stainless steel, and therefore the constituent member of the sliding body except for the contact and the float arm are made of the same material, and hence have the same oxidation-reduction potential. Therefore, a potential chemical reaction will not occur between the two, and the high durability against the electrolyte such as ethanol can be maintained.

In the present invention, at least the surface of the constituent member of the sliding body except for the contact is made of the material having the corrosion resistance to the liquid whose liquid level is to be detected, and therefore will not be corroded by this liquid, and the excellent durability can be maintained. In the invention, when the constituent member of the sliding body except for the contact and the float arm are made of stainless steel, the corrosion resistance is secured by the (passive) oxide film formed on their surfaces, and besides the two have the same oxidation-reduction potential, so that a potential chemical reaction between the two is prevented. Therefore, there can be obtained the liquid level detecting apparatus having the high durability.

The present invention has been briefly described above, and details of the invention will become more manifest upon reading the following Section “Best Mode for Carrying Out the Invention” with reference to the accompanying drawings.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a plan view showing the construction of one preferred embodiment of a liquid level detecting apparatus of the present invention;

FIG. 2 is a perspective view of a sliding body shown in FIG. 1;

FIG. 3 is a side-elevational view of the sliding body;

FIG. 4 is a plan view of the sliding body; and

FIG. 5 is a view showing the reverse side of the sliding body.

### DETAILED DESCRIPTION OF EXEMPLARY EMBODIMENTS

A preferred embodiment of the present invention will now be described in detail with reference to the drawings.

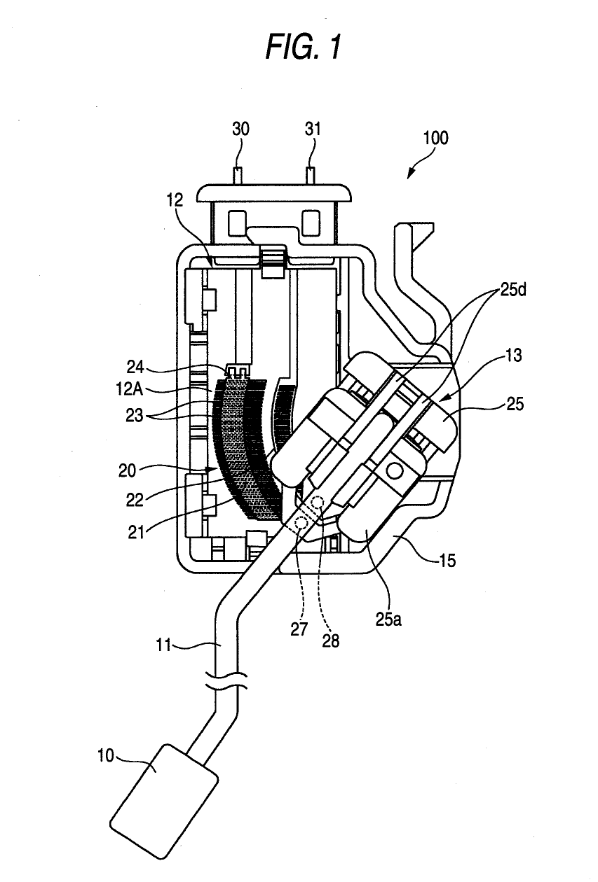

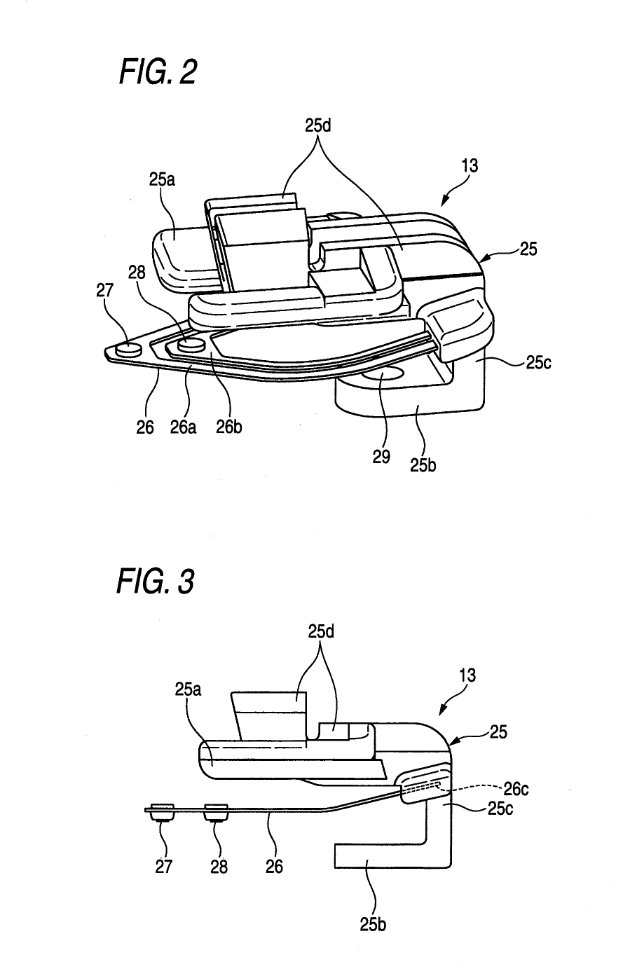

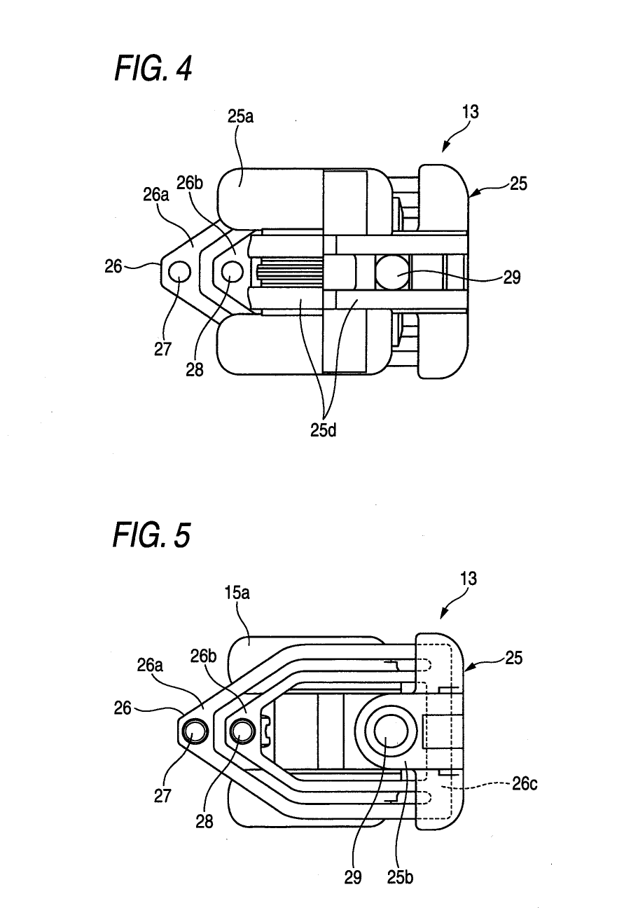

FIG. 1 is a plan view showing the construction of one preferred embodiment of a liquid level detecting apparatus of the invention, FIG. 2 is a perspective view of a sliding body shown in FIG. 1, FIG. 3 is a side-elevational view of the sliding body, FIG. 4 is a plan view of the sliding body, and FIG. 5 is a view showing the reverse side of the sliding body.

As shown in FIG. 1, the liquid level detecting apparatus 100 of this embodiment is mounted on an automobile in order to detect a height of a liquid surface of fuel within a fuel tank, and this apparatus comprises a float 10 for moving upward and downward in accordance with a change of a liquid level to be measured, a float arm 11, a resistance plate 12, and the sliding body 13.

More specifically, the float 10 floating on the liquid surface of the fuel within the fuel tank is supported on a distal end of the float arm 11. A proximal end portion of the float arm 11 bent to extend in a direction perpendicular to the sheet of FIG. 1 is rotatably supported by a bearing portion (not shown) provided at a frame 15. The resistance plate 12 and the sliding body 13 for sliding over the resistance plate 12 in accordance with a pivotal movement of the float arm 11 are provided at the frame 15.

A conducting pattern 20 is provided on the resistance plate 12, the conducting pattern 20 being made of silver palladium which has excellent electrical conductivity and also is excellent in deterioration resistance and corrosion resistance. The conducting pattern 20 includes a generally arc-shaped first slide portion 21, and a generally arc-shaped second slide portion 22, the first and second slide portions 21 and 22 being formed on an insulating board 12A.

The first slide portion 21 includes a plurality of conductive segments 23 arranged at intervals in a direction of sliding movement of the sliding body 13. A resistor 24 of an arc-shape is formed on the plurality of conductive segments 23. The resistor 24 is a resistance layer made of ruthenium oxide which is excellent in sulfur resistance and besides is less liable to be deteriorated and corroded by electrolysis even when it is exposed to an electrolyte such as ethanol and methanol. The adjacent conductive segments 23 are connected together via the resistor 24.

The second slide portion 22 is made of an electrically-conductive material (silver palladium), and is formed into an arc-shape. The first slide portion 21 and the second slide portion 22 are electrically connected to output terminals 30 and 31, respectively.

As shown in FIGS. 2 to 5, the sliding body 13 comprises an arm holder 25, a contact spring 26, a first contact 27, and a second contact 28, the first and second contacts 27 and 28 being fixed to a distal end portion of the contact spring 26. The arm holder 25 includes an upper holding portion 25a, a lower holding portion 25b disposed parallel to the upper holding portion 25a, and an interconnecting portion 25c interconnecting the upper and lower holding portions 25a and 25b, the arm holder 25 having a generally U-shape (see FIG. 3) when viewed from the side thereof. The arm holder 25 is formed by injection molding a synthetic resin.

A shaft hole 29 for the passage of the proximal end portion of the float arm 11 therethrough is formed through the upper holding portion 25a and the lower holding portion 25b. A pair of side walls 25d are formed in an upstanding manner on an upper surface of the upper holding portion 25a. The float arm 11 passing through the shaft hole 29 is held between the pair of side walls 25d. With this construction, the arm holder 25 (the sliding body 13) is pivotally moved together with the float arm 11 when this float arm 11 is pivotally moved in accordance with a change of the liquid level. The float arm 11 is formed by bending a stainless steel wire into a predetermined shape.

The contact spring 26 is formed of a thin sheet made of stainless steel having a high corrosion resistance, and includes a first contact holding portion 26a of a generally V-shape, a second contact holding portion 26b of a generally V-shape disposed parallel relation to the first contact holding portion 26b, and a proximal end portion 26c interconnecting the first contact holding portion 26a and the second contact holding portion 26b such that the two contact holding portions 26a and 26b are electrically connected together via the proximal end portion 26c. The proximal end portion 26c is insert molded in the upper holding portion 25a of the arm holder 25, and therefore is fixed to this upper holding portion 25a. The first contact 27 for sliding over the first slide portion 21 is fixed to the distal end portion of the first contact holding portion 26a, and the second contact 28 for sliding over the second slide portion 22 is fixed to the distal end portion of the second contact holding portion 26b. The first contact 27 and the second contact 28 are made of gold or gold alloy. Each of the first and second contacts 27 and 28 may be made of copper or copper alloy, in which case gold or gold alloy is plated on the surface of this copper or copper alloy substrate.

The contact spring 26 has electrical conductivity and resiliency, and presses the first and second contacts 27 and 28 respectively against the first and second slide portions 21 and 22 by its own resiliency. The first contact 27 of the sliding body 13 contacts the corresponding conductive segment 23, while the second contact 28 of the sliding body 13 contacts the corresponding second slide portion 22, so that the first slide portion 21 and the second slide portion 22 are electrically connected together via the contact spring 26.

In the liquid level detecting apparatus 100 of this embodiment, the contact spring 26 (which is the constituent member of the sliding body 13 except for the first and second contacts 27 and 28), as well as the float arm 11, is made of stainless steel. Therefore, even when the liquid level detecting apparatus 100 is immersed in an electrolyte or gasoline containing an electrolyte, chromium (Cr) contained in the stainless steel reacts with oxygen (O₂) contained in the electrolyte to form an oxide film in the passive state on the surfaces of the contact plate 26 and float arm 11, thereby preventing corrosion due to the electrolyte.

In the conventional liquid level detecting apparatus, the constituent member of the sliding body except for the contact is made of copper alloy such as nickel silver for a spring and phosphor bronze for a spring, and the float arm is formed of a galvanized steel wire. Therefore, when the conventional liquid level detecting apparatus is immersed in an electrolyte, a potential difference develops between the metals of different kinds because of the difference in ionization tendency between the metals, and an electrochemical reaction occurs in accordance with this potential difference, so that the metals are corroded. And besides, when a voltage is applied between the metals, an oxidation-reduction reaction of the metals is promoted, so that ion concentrations in the solution change.

However, in the liquid level detecting apparatus 100 of the invention, the contact spring 26 (which is the constituent member of the sliding body 13 except for the first and second contacts 27 and 28) and the float arm 11 are both made of stainless steel (the same material), and therefore have the same oxidation-reduction potential, and an electrochemical reaction will not occur between the two, and corrosion is prevented. Incidentally, when one of the contact spring 26 and the float arm 11 is made of stainless steel, a certain degree of corrosion resistance can be expected. However, it is more preferred that the two should be made of the same material.

The present invention is not limited to the above embodiment, and suitable modifications, improvements, etc., can be made. Furthermore, the material, shape, dimensions, numerical values, form, number, disposition, etc., of each of the constituent elements of the above embodiment are arbitrary and are not limited in so far as the invention can be achieved.

In the above embodiment, although the contact spring 26 is made of stainless steel, the contact spring 26 is not limited to this material, and can be made of any other suitable material exhibiting a high corrosion resistance to an electrolyte. For example, titanium can be used. Like stainless steel, titanium forms an oxide film (passive film) on a metal surface, and therefore excellent in corrosion resistance.

In another modified example, the contact spring 26 can be made of nickel alloy having an excellent corrosion resistance. For example, Hastelloy B (Trademark of Haynes International, Inc.) or Hastelloy C which have produced actual results in petrochemical apparatuses, pickling apparatuses, etc., can be used.

In a further modified example, the contact spring 26 can be made of copper alloy such as nickel silver for a spring and phosphor bronze for a spring, in which case nickel or gold having a low reactivity with an electrolyte is plated on the surface of the contact spring 26 so as to prevent the dissolving of copper and copper alloy. In this case, preferably, the float arm 11 is made of the same material as the material of the contact spring 26 so that the two can have the same oxidation-reduction potential.

What is claimed is:

1. A liquid level detecting apparatus comprising:
a resistance plate which includes an insulating plate and a resistor mounted on the insulating plate, the resistor having a plurality of conductive segments; and
a sliding body which has a contact for contacting on the conductive segments, and the contact sliding over the conductive segments in accordance with a change of a liquid level of a liquid,
wherein at least a surface of a constituent member of the sliding body except for the contact is comprised of a material having a corrosion resistance to the liquid.

2. The liquid level detecting apparatus according to claim 1, wherein the constituent member of the sliding body except for the contact is comprised of stainless steel.

3. The liquid level detecting apparatus according to claim 2, further comprising:
a float which is displaced in accordance with the change of the liquid level of the liquid; and
a float arm which interconnects the sliding body and the float, and moves the sliding body in accordance with a displacement of the float,
wherein the float arm is comprised of the stainless steel.

4. The liquid level detecting apparatus according to claim 1, wherein the constituent member of the sliding body except for the contact is comprised of copper alloy, and is plated with nickel or gold.

5. The liquid level detecting apparatus according to claim 4, wherein the copper alloy is nickel silver for a spring or phosphor bronze for the spring; and
wherein the nickel silver for the spring or the phosphor bronze for the spring is prevented from a dissolving of copper by the plated nickel or the plated gold.
